(19) United States
(12) Patent Application Publication
(10) Pub. No.: US 2026/0005285 A1
(43) Pub. Date: Jan. 1, 2026

(54) SECONDARY BATTERY

(71) Applicant: SAMSUNG SDI CO., LTD., Yongin-Si (KR)

(72) Inventor: Jiwon YUN, Yongin-Si (KR)

(21) Appl. No.: 18/946,658

(22) Filed: Nov. 13, 2024

(30) Foreign Application Priority Data
Jun. 27, 2024 (KR) 10-2024-0084719

(51) Int. Cl. H01M 10/04; H01M 50/109; H01M 50/153; H01M 50/536; H01M 50/538

(52) U.S. Cl. CPC H01M 10/0431; H01M 50/109; H01M 50/153; H01M 50/536; H01M 50/538

(57) ABSTRACT

The secondary battery may include an electrode assembly comprising a jelly roll including a first electrode and a second electrode, a case having an opening formed at one side and accommodating the electrode assembly and an electrolyte, and a cap assembly coupled to the opening of the case, wherein the electrode assembly includes a first electrode tab electrically connecting the first electrode to the cap assembly, a cover tape attaching the first electrode tab to the jelly roll, and an adhesive member disposed between the cover tape and the cap assembly.

### CROSS-REFERENCE TO RELATED APPLICATION

The present application claims priority to and the benefit of Korean Application No. 10-2024-0084719, filed on Jun. 27, 2024, in the Korean Intellectual Property Office, the entire disclosure of which is incorporated herein by reference.

### BACKGROUND

### 1. Field

Aspects of embodiments of the present disclosure relate to a secondary battery.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

In the secondary battery, the electrode assembly may be accommodated in the case. Electrode tabs of the electrode assembly may be bonded to the case and the cap assembly by welding. However, the bonding of the welded portion may weaken due to movements such as rotation of the electrode assembly inside the case. Therefore, it may be beneficial to prevent or at least mitigate the movement of the electrode assembly within the case.

The above information disclosed in this Background section is for enhancement of understanding of the background of the present disclosure, and therefore, it may contain information that does not constitute related (or prior) art.

### SUMMARY

Embodiments of the present disclosure provide a secondary battery.

These and other aspects and features of the present disclosure will be described in or will be apparent from the following description of embodiments of the present disclosure.

According to one embodiment of the present disclosure, a secondary battery may include an electrode assembly including a jelly roll including a first electrode and a second electrode, a case having an opening at one side and accommodating the electrode assembly and an electrolyte, and a cap assembly coupled to the opening of the case. The electrode assembly includes a first electrode tab electrically connecting the first electrode to the cap assembly, a cover tape attaching the first electrode tab to the jelly roll, and an adhesive member between the cover tape and the cap assembly.

According to one embodiment of the present disclosure, the cover tape may include a first film layer that generates an adhesive force by reacting with the electrolyte.

According to one embodiment of the present disclosure, the first film layer may include oriented polystyrene (OPS).

According to one embodiment of the present disclosure, the cover tape may further include a second film layer on the first film layer.

According to one embodiment of the present disclosure, the second film layer may include polyethylene terephthalate (PET).

According to one embodiment of the present disclosure, the first electrode tab and the cap assembly may be coupled by welding.

According to one embodiment of the present disclosure, the adhesive member may be at one side of the first electrode tab and may be on the second film layer.

According to one embodiment of the present disclosure, the adhesive member may include acrylic.

According to one embodiment of the present disclosure, the cover tape may be a first cover tape, and the electrode assembly may further include a second electrode tab electrically connecting the second electrode with the case, and a second cover tape attaching the second electrode tab to the jelly roll.

According to one embodiment of the present disclosure, the adhesive member may be a first adhesive member, and the secondary battery may further include a second adhesive member between the second cover tape and a bottom portion of the case.

According to one embodiment of the present disclosure, the second cover tape may include a first film layer that generates adhesive force by reacting with the electrolyte, and a second film layer on the first film layer.

According to one embodiment of the present disclosure, the jelly roll may be wound into a cylindrical shape, and the secondary battery may further include a securing tape that attaches the jelly roll to a sidewall portion of the case.

According to one embodiment of the present disclosure, the securing tape may be on an outer peripheral surface of the electrode assembly.

According to one embodiment of the present disclosure, the securing tape may include a first film layer that generates adhesive force by reacting with the electrolyte.

According to one embodiment of the present disclosure, a secondary battery may include an electrode assembly including a jelly roll wound into a cylindrical shape, the jelly roll including a first electrode and a second electrode, a cylindrical case having an opening formed at one side and accommodating the electrode assembly and an electrolyte, a cap assembly coupled to the opening of the case, and a securing tape attaching the jelly roll to a sidewall portion of the case. The electrode assembly includes a first electrode tab electrically connecting the first electrode to the cap assembly, a cover tape including a first film layer that generates adhesive force by reacting with the electrolyte to attach the first electrode tab to the jelly roll, and a second film layer on the first film layer, and an adhesive member between the cover tape and the cap assembly.

According to one embodiment of the present disclosure, the first film layer may include oriented polystyrene (OPS), and the second film layer may include polyethylene terephthalate (PET).

According to one embodiment of the present disclosure, the first electrode tab and the cap assembly may be coupled by welding, and the adhesive member may be at one side of the first electrode tab and may be on the second film layer.

According to one embodiment of the present disclosure, the cover tape may be a first cover tape, and the electrode assembly may further include a second electrode tab electrically connecting the second electrode with the case, and a second cover tape attaching the second electrode tab to the jelly roll.

According to one embodiment of the present disclosure, the adhesive member may a first adhesive member, and the secondary battery may further include a second adhesive member between the second cover tape and a bottom portion of the case.

According to one embodiment of the present disclosure, a secondary battery may include an electrode assembly including a jelly roll wound into a cylindrical shape, the jelly roll including a first electrode and a second electrode, a cylindrical case having an opening at one side end and accommodating the electrode assembly and an electrolyte, a cap assembly coupled to the opening of the case, and a securing tape attaching the jelly roll to a sidewall portion of the case. The electrode assembly includes a first electrode tab electrically connecting the first electrode to the cap assembly, a second electrode tab electrically connecting the second electrode to the case, a first cover tape includes a first film layer that generates adhesive force by reacting with the electrolyte to attach the first electrode tab to the jelly roll, and a second film layer on the first film layer, a second cover tape including a first film layer that generates adhesive force by reacting with the electrolyte to attach the second electrode tab to the jelly roll, and a second film layer disposed on the first film layer, a first adhesive member between the first cover tape and the cap assembly, and a second adhesive member between the second cover tape and the bottom portion of the case.

According to various embodiments of the present disclosure, the mechanical and electrical reliability of the secondary battery can be improved.

According to various embodiments of the present disclosure, the movement of the electrode assembly inside the secondary battery can be prevented or at least mitigated (minimized or at least reduced).

According to various embodiments of the present disclosure, the reliability of the welded portions of the electrode tabs of the electrode assembly can be enhanced.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a perspective view of a secondary battery according to one embodiment of the present disclosure.

FIG. 2 is an exploded view of a secondary battery according to one embodiment of the present disclosure.

FIG. 3 is a cross-sectional view of a secondary battery according to one embodiment of the present disclosure.

FIG. 4 is a top view illustrating a partial configuration of a secondary battery according to one embodiment of the present disclosure.

FIG. 5 is a cross-sectional view schematically illustrating a coupling structure between a cap assembly and a first electrode tab.

FIG. 6 is a cross-sectional view schematically illustrating a coupling structure between the case and the second electrode tab.

FIG. 7 is an exploded view of a secondary battery according to one embodiment of the present disclosure.

FIG. 8 is a cross-sectional view of a secondary battery according to one embodiment of the present disclosure.

FIG. 9 is a cross-sectional view schematically illustrating a coupling structure between a case and a jelly roll.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

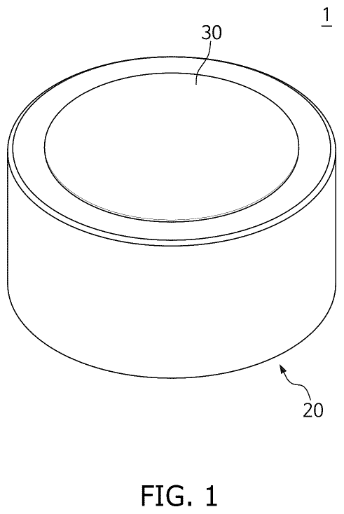

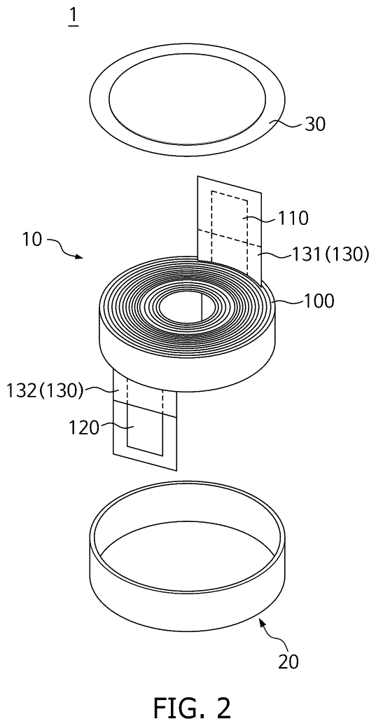

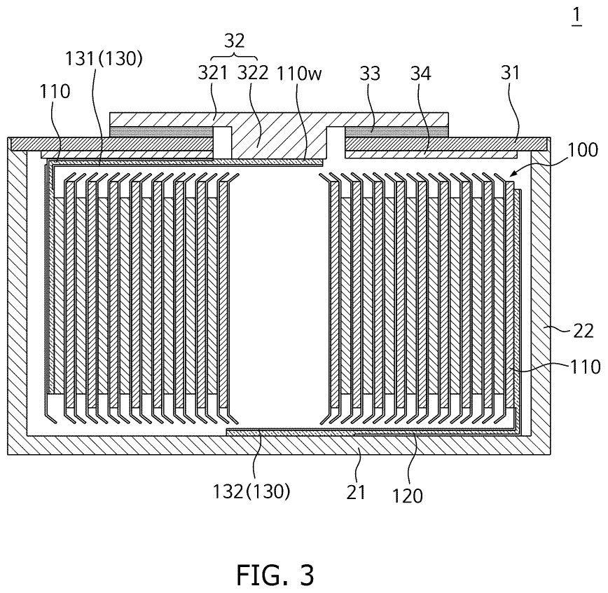

FIG. 1 is a perspective view of a secondary battery according to one embodiment of the present disclosure. FIG. 2 is an exploded view of a secondary battery according to one embodiment of the present disclosure. FIG. 3 is a cross-sectional view of a secondary battery according to one embodiment of the present disclosure.

Referring to FIGS. 1 to 3, a secondary battery 1 may include an electrode assembly 10, a case 20, and a cap assembly 30.

The secondary battery 1 may be a coin-type secondary battery or a button-type secondary battery. For example, the secondary battery may have a cylinder shape. However, the shape of the secondary battery is not limited thereto, and the secondary battery may have a cylindrical or a prismatic shape.

The electrode assembly 10 may include a jelly roll 100 including a first electrode, a second electrode, and a separator. In one or more embodiments, the jelly roll 100 may be configured (formed) by winding the first electrode and the second electrode together with the separator between the first electrode and the second electrode. The jelly roll 100 may be wound to form a winding core and may include a through-hole in the winding core. The separator of the electrode assembly 10 may be longer in a height direction of the electrode assembly 10 than the first electrode and the second electrode.

The first electrode may include a first substrate and a first active material layer on the first substrate. A first electrode tab 110 may extend outward (e.g., upward) from a first uncoated portion of the first substrate where the first active material layer is not applied. The first electrode tab 110 may be electrically connected to a terminal plate 32 of the cap assembly 30.

The second electrode may include a second substrate and a second active material layer on the second substrate. A second electrode tab 120 may extend outward (e.g., downward) from a second uncoated portion of the second substrate where the second active material layer is not applied. The second electrode tab 120 may be electrically connected to the case 20. The first electrode tab 110 and the second electrode tab 120 may extend in opposite (or substantially opposite) directions from each other.

The first electrode may be configured to function as a positive electrode. In this case, the first substrate may be, for example, aluminum foil, and the first active material layer may include, for example, a transition metal oxide. The second electrode may be configured to function as a negative electrode. In this embodiment, the second substrate may be, for example, copper foil or nickel foil, and the second active material layer may include, for example, graphite.

The separator may be configured to prevent (or at least mitigate) a short circuit between the first electrode and the second electrode while allowing movement of lithium ions therebetween. The separator may be, for example, a polyethylene film, a polypropylene film, a polyethylene-polypropylene film, or the like, but the scope of the present disclosure is not limited thereto.

The electrode assembly 10 may include the first electrode tab 110, the second electrode tab 120, and a cover tape 130. Each of the first electrode tab 110 and the second electrode tab 120 may be covered with the cover tape 130. The cover tape 130 may include a first cover tape 131 that covers the first electrode tab 110 and a second cover tape 132 that covers the second electrode tab 120. The cover tape 130 may include an insulating material. The insulating material may be configured to provide electrical insulation to prevent current from passing therethrough. As a result, the cover tape 130 may prevent (or at least mitigate) short circuits from occurring at the first electrode tab 110 and the second electrode tab 120.

The first electrode tab 110 of the first electrode may be on one side (e.g., the upper side) of the electrode assembly 10. The second electrode tab 120 of the second electrode may be on the opposite side (e.g., the lower or bottom side) of the electrode assembly 10. However, the scope of the present disclosure is not limited thereto, and, for example, both the first electrode tab 110 and the second electrode tab 120 may be on the same side (e.g., the upper side or the lower side) of the electrode assembly 10.

The case 20 may accommodate the electrode assembly 10 and an electrolyte, and may form an external appearance of the secondary battery 1 together with the cap assembly 30. The case 20 may include a cylindrical sidewall portion 22 and a bottom portion 21 connected to one side of the sidewall portion 22. However, the shape of the case 20 is not limited thereto, and the case 20 may be configured in various shapes, such as a circular shape or the like. Additionally, the case may be composed of metals such as aluminum, an aluminum alloy, or a nickel-plated steel, or materials such as a laminated film or plastic used for a pouch.

The case 20 may accommodate the electrode assembly 10. The electrode assembly 10 may be inserted into the case 20 through an opening at one side (e.g., the upper side) of the case 20. Afterward, the opening of the case 20 may be sealed by the cap assembly 30. The cap assembly 30 may be coupled to one side (e.g., the upper side) of the case 20. The region where the case 20 and the cap assembly 30 come into contact may be welded to secure the coupling between the case 20 and the cap assembly 30.

The cap assembly 30 may include a cap plate 31, the terminal plate 32, an insulating layer 33, and an insulating member 34. Here, the cap plate 31 may cover the opening of the case 20. The cap plate 31 may be coupled to a side surface of the case 20 corresponding to a side surface of the opening.

An insertion hole may be at the cap plate 31. In one or more embodiments, the insertion hole may be at the center (or substantially the center) of the cap plate 31. The terminal plate 32 may be inserted into the insertion hole, allowing the terminal plate 32 to be coupled to the cap plate 31. The terminal plate 32 may include a body portion 321 and an insertion portion 322 protruding from the body portion 321. The insertion portion 322 of the terminal plate 32 may be inserted into the insertion hole of the cap plate 31. Additionally, the first electrode tab 110 may be connected to the terminal plate 32 by contacting the insertion portion 322 with the first electrode tab 110. The cap assembly 30 may be coupled to the case 20 such that the insertion portion 322 of the terminal plate 32 faces the electrode assembly 10.

The insulating layer 33 may be between the terminal plate 32 and the cap plate 31. The insulating layer 33 may have adhesive properties to thereby bond the terminal plate 32 and the cap plate 31 together. The insulating layer 33 may include an insulating material to electrically insulate the terminal plate 32 and the cap plate 31.

In one embodiment, the insulating member 34 may be on a bottom surface of the cap plate 31. A top surface of the cap plate 31 may face the body portion 321 of the terminal plate 32, and the bottom surface of the cap plate 31 may face the electrode assembly 10. The insulating member 34 may include an insulating material configured to provide electrical insulation between the cap plate 31 and the electrode assembly 10 or between the cap plate 31 and the first electrode tab 110.

The first electrode tab 110 may be bent to make contact with the terminal plate 32. The bent first electrode tab 110 may be prevented from short-circuiting with the jelly roll 100 by the first cover tape 131. However, the scope of the present disclosure is not limited thereto, and, for example, an insulating washer or similar component may be between the first electrode tab 110 and the jelly roll 100 to prevent (or at least mitigate) short-circuiting. The insulating washer may include an insulating material. Due to the insulating washer, the first electrode tab 110 may be spaced apart from the jelly roll 100. Further, the insulating washer may provide electrical insulation between the first electrode tab 110 and the jelly roll 100.

The second electrode tab 120 may be bent to contact the bottom portion 21 of the case 20. The bent second electrode tab 120 may be prevented from short-circuiting with the jelly roll 100 by the second cover tape 132.

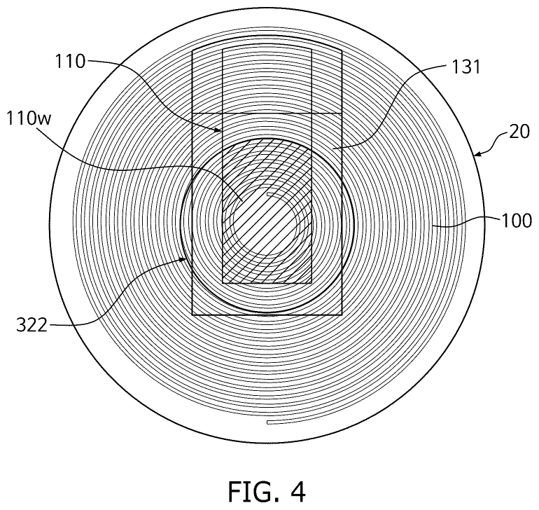

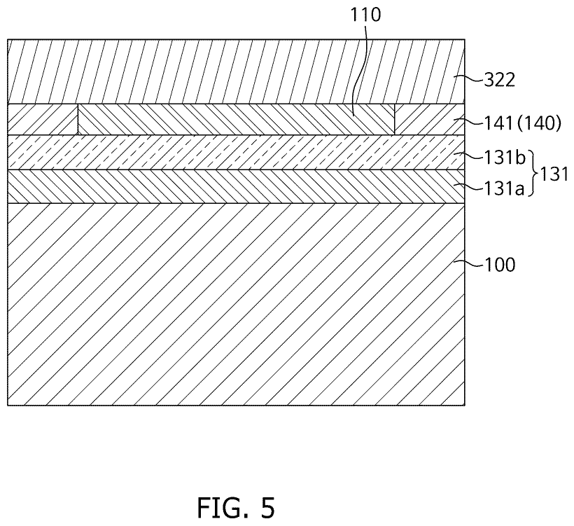

FIG. 4 is a top view illustrating a partial configuration of a secondary battery according to one embodiment of the present disclosure. FIG. 5 is a cross-sectional view schematically illustrating a coupling structure between a cap assembly and a first electrode tab.

Referring to FIGS. 4 and 5, the first electrode tab 110 may be coupled to the insertion portion 322 of the terminal plate 32. In one or more embodiments, the first electrode tab 110 may be coupled to the insertion portion 322 of the terminal plate 32 by welding. The first electrode tab 110 may include a welding region 110w that overlaps with the insertion portion 322 of the terminal plate. The welding may be performed with the insertion portion 322 of the terminal plate in the welding region 110w.

The first cover tape 131 may be used to attach the first electrode tab 110 to the jelly roll 100. The first cover tape 131 may be between the first electrode tab 110 and the jelly roll 100. The first cover tape 131 may include a first film layer 131a and a second film layer 131b. The first film layer 131a may react with an electrolyte to generate an adhesive force. Through the first film layer 131a, the first electrode tab 110 may be attached to the jelly roll 100. Therefore, even if the jelly roll 100 moves, damage to the welded portion between the first electrode tab 110 and the insertion portion 322 of the terminal plate 32 can be prevented or at least mitigated. In one or more embodiments, the first film layer 131a may include oriented polystyrene (OPS). However, the scope of the present disclosure is not limited thereto, and the first film layer 131a may include various material(s) that react(s) with the electrolyte to generate the adhesive force.

The first film layer 131a may correspond to an OPS film. The OPS film does not normally have an adhesive property, but the OPS film may have the adhesive property when reacting with a certain component of the electrolyte, for example, dimethyl carbonate (DMC). In one or more embodiments, the OPS film is a solid-state film that generally does not have the adhesive property. However, if the OPS films react with the DMC, the DMC penetrates the pores of the polymer chains, so that the polymer chains changes to a movable state allowing easy movement and has the adhesive property. In other words, the OPS film reacts with the DMC to shift its phase from a solid state to a viscous liquid state, which gives the OPS film the adhesive property. Therefore, in an embodiment in which the electrolyte is injected into the case, the adhesive property of the OPS film is exhibited.

Additionally, the OPS film, which has reacted with the electrolyte to shift its phase into a viscous liquid state, may start a shrinking reaction by thermal treatment of about 60° C. and become slowly solidified while losing the solvent component gradually. Therefore, the OPS film may be solidified again by performing a thermal treatment process after a predetermined period of time has elapsed following the injection of the electrolyte into the case. In one or more embodiments, the thermal treatment process may be a process included in an existing secondary battery manufacturing process or an additional separate process.

While the DMC has been given as an example of the component of the electrolyte that reacts with the OPS film to exhibit the adhesive property of the OPS film, it is merely an example. The OPS film may exhibit its adhesive property by means of other nonpolar solvents such as toluene and/or xylene.

The OPS film may have a tensile strength of at least approximately 200 kgf/cm², such as in a range from approximately (about) 200 kgf/cm² to approximately (about) 600 kgf/cm². In one or more embodiments, the OPS film is capable of withstanding the pressure applied during the charging and discharging of the electrode.

The electrolyte solution for a rechargeable lithium battery may include a non-aqueous organic solvent and a lithium salt.

The non-aqueous organic solvent may serve as a medium for transmitting ions taking part in the electrochemical reaction of a battery.

The non-aqueous organic solvent may be a carbonate-based, ester-based, ether-based, ketone-based, or alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include methyl acetate, ethyl acetate, n-propyl acetate, dimethyl acetate, methyl propionate, ethyl propionate, decanolide, mevalonolactone, valerolactone, caprolactone, and the like.

The ether-based solvent may include dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like and the aprotic solvent may include nitriles such as R—CN (wherein R is a C2 to C20 linear, branched, or cyclic hydrocarbon group, a double bond, an aromatic ring, or an ether bond, and the like; amides such as dimethylformamide; dioxolanes such as 1,3-dioxolane, 1,4-dioxolane, and the like; sulfolanes, and the like.

The non-aqueous organic solvents may be used alone or in combination of two or more.

In addition, when using a carbonate-based solvent, a cyclic carbonate and a chain carbonate may be mixed and used, and the cyclic carbonate and the chain carbonate may be mixed in a volume ratio of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of the lithium salt include at least one selected from LiPF6, LiBF4, LiSbF6, LiAsF6, LiClO4, LiAlO2, LiAlCl4, LIPO2F2, LiCl, LiI, LiN(SO3C2F5)2, Li(FSO2)2N (lithium bis(fluorosulfonyl)imide, LiFSI), LiC4F9SO3, LiN(CxF2x+1SO2)(CyF2y+1SO2) (wherein x and y are integers of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

The second film layer 131b may be on the first film layer 131a. The first electrode tab 110 may be on the second film layer 131b. The second film layer 131b may cover a portion of the first electrode tab 110. The second film layer 131b may surround a portion of the first electrode tab 110 on both sides and expose another portion of the first electrode tab 110 on one side. The second film layer 131b may prevent or at least mitigate the first electrode tab 110 from short-circuiting with other components. In one or more embodiments, the second film layer 131b may include polyethylene terephthalate (PET). However, the scope of the present disclosure is not limited thereto, and the second film layer 131b may include various insulating materials.

The second film layer 131b may be an electrolyte-insoluble film. Materials for the electrolyte-insoluble film may include, for example, polyethylene terephthalate (PET), polyimide (PI), polyethylene (PE), or polypropylene (PP).

An adhesive member 140 may be provided to surround the first electrode tab 110. The adhesive member 140 may include acrylic. For example, a first adhesive member 141 may be at one side (e.g., an outer periphery) of the first electrode tab 110. The first electrode tab 110 may be coupled to the insertion portion 322 of the terminal plate 32 by welding. The second film layer 131b of the first cover tape 131 may be attached to the insertion portion 322 of the terminal plate 32 by the first adhesive member 141.

The jelly roll 100 may be coupled to the terminal plate 32 by the first cover tape 131. Thus, even if the jelly roll 100 rotates or moves in the case 20, damage to the welded portion between the first electrode tab 110 and the insertion portion 322 of the terminal plate 32 can be prevented or at least mitigated.

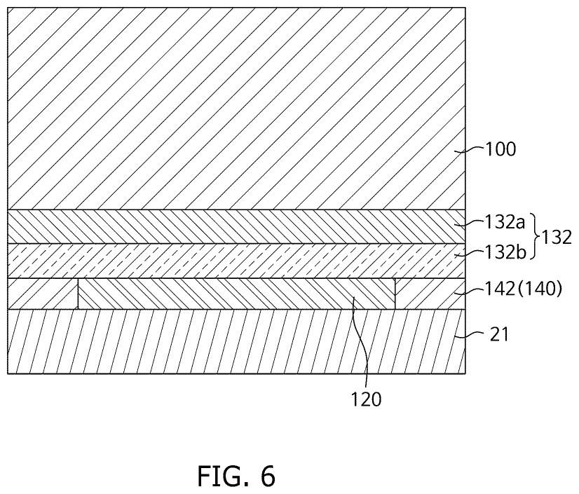

FIG. 6 is a cross-sectional view schematically illustrating a coupling structure between the case and the second electrode tab.

Referring to FIG. 6, the second electrode tab 120 may be coupled to the bottom portion 21 of the case 20. In one or more embodiments, the second electrode tab 120 may be coupled to the bottom portion 21 of the case 20 by welding.

The second cover tape 132 may be used to attach the second electrode tab 120 to the jelly roll 100. The second cover tape 132 may be between the second electrode tab 120 and the jelly roll 100. The second cover tape 132 may include a first film layer 132a and a second film layer 132b.

The first film layer 132a may react with the electrolyte to generate an adhesive force. Through the first film layer 132a, the second electrode tab 120 may be attached to the jelly roll 100. Therefore, even if the jelly roll 100 moves, damage to the welded portion between the second electrode tab 120 and the bottom portion 21 of the case 20 can be prevented or at least mitigated.

The second film layer 132b may be on the first film layer 132a. The second electrode tab 120 may be on the second film layer 132b. The second film layer 132b may cover a portion of the second electrode tab 120. The second film layer 132b may surround a portion of the second electrode tab 120 on both sides and expose another portion of the second electrode tab 120 on one side. The second film layer 132b may prevent or at least mitigate the second electrode tab 120 from short-circuiting with other components.

The description of each of the first film layer 131a and the second film layer 131b of the first cover tape 131 may be similarly applied to the description of each of the first film layer 132a and the second film layer 132b, respectively, of the second cover tape 132.

The adhesive member 140 may be provided to surround the second electrode tab 120. In one or more embodiments, a second adhesive member 142 may be at one side of the second electrode tab 120. The second electrode tab 120 may be coupled to the bottom portion 21 of the case 20 by welding. The second film layer 132b of the second cover tape 132 may be attached to the bottom portion 21 of the case 20 by the second adhesive member 142. The description of the first adhesive member 141 may be similarly applied to the description of the second adhesive member 142.

The jelly roll 100 may be coupled to the case 20 by the second cover tape 132. Thus, even if the jelly roll 100 rotates or moves in the case 20, damage to the welded portion between the second electrode tab 120 and the bottom portion 21 of the case 20 can be prevented or at least mitigated.

Hereinafter, secondary batteries according to alternative embodiments of the present disclosure will be described. Like reference numerals will be given to like parts as those in the aforementioned embodiments, and redundant description thereof will be omitted.

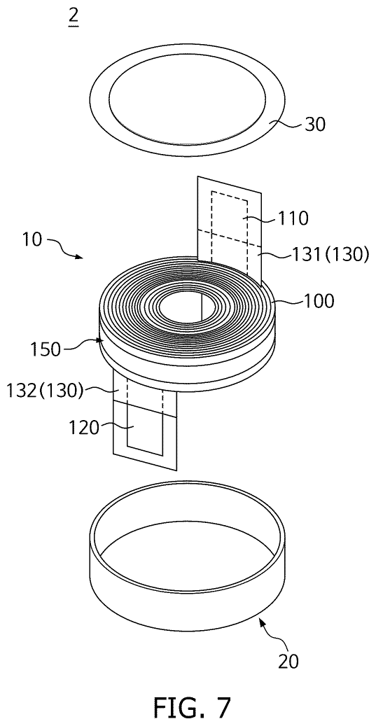

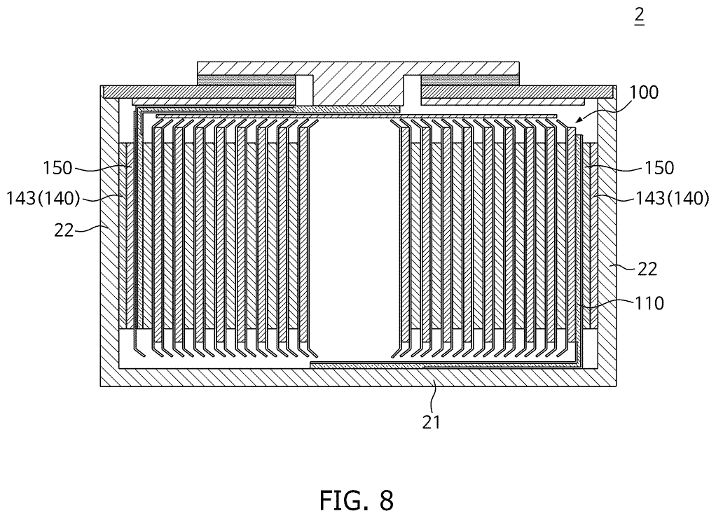

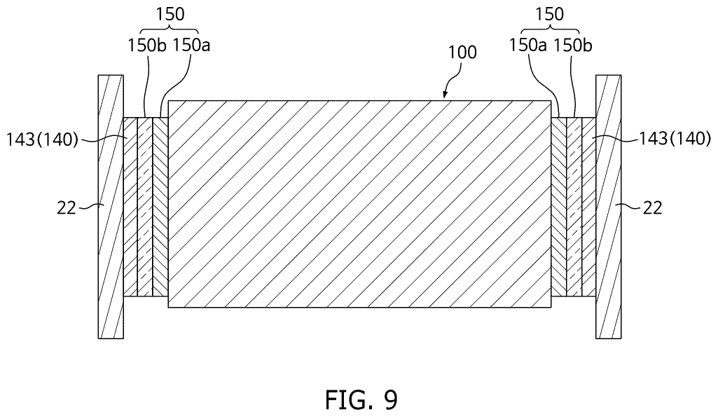

FIG. 7 is an exploded view of a secondary battery according to one embodiment of the present disclosure. FIG. 8 is a cross-sectional view of a secondary battery according to one embodiment of the present disclosure. FIG. 9 is a cross-sectional view schematically illustrating a coupling structure between a case and a jelly roll.

Referring now to FIGS. 7 to 9, a secondary battery 2 according to one embodiment of the present disclosure may include a securing tape 150 on an outer peripheral surface of the electrode assembly 10. In one or more embodiments, the securing tape 150 may be on the outer peripheral surface of the jelly roll 100. The securing tape 150 may be used to attach the jelly roll 100 to the sidewall portion 22 of the case 20.

The securing tape 150 may include a first film layer 150a and a second film layer 150b. The first film layer 150a may react with an electrolyte to generate an adhesive force. The second film layer 150b may be on the first film layer 150a. The first film layer 150a may provide the adhesive force between the second film layer 150b and the jelly roll 100. A third adhesive member 143 may be on the second film layer 150b. The third adhesive member 143 may provide an adhesive force between the second film layer 150b and the sidewall portion 22 of the case 20. In other words, the jelly roll 100 and the sidewall portion 22 of the case 20 may be attached to each other by the securing tape 150 and the third adhesive member 143.

The first cover tape 131 may reinforce the coupling between the jelly roll 100 and the insertion portion 322 of the terminal plate 32, and the second cover tape 132 may reinforce the coupling between the jelly roll 100 and the bottom part 21 of the case 20. In addition, the secondary battery 2 according to one embodiment of the present disclosure may prevent or at least reduce movement such as rotation of the jelly roll 100 by using the securing tape 150 to provide an adhesive force between the jelly roll 100 and the sidewall portion 22 of the case 20. Therefore, according to the secondary battery 2 of the present disclosure, a reduction in the strength of the welded portions of the first electrode tab 110 and the second electrode tab 120 can be prevented or at least mitigated (minimized or at least reduced), and both mechanical and electrical reliability of the secondary battery 2 can be improved.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. A secondary battery comprising:
an electrode assembly comprising a jelly roll comprising a first electrode and a second electrode;
a case comprising an opening at one side, the case accommodating the electrode assembly and an electrolyte; and
a cap assembly coupled to the opening of the case;
wherein the electrode assembly comprises:
a first electrode tab electrically connecting the first electrode to the cap assembly;
a cover tape attaching the first electrode tab to the jelly roll; and
an adhesive member between the cover tape and the cap assembly.

2. The secondary battery as claimed in claim 1, wherein the cover tape comprises a first film layer that generates an adhesive force by reacting with the electrolyte.

3. The secondary battery as claimed in claim 2, wherein the first film layer comprises oriented polystyrene (OPS).

4. The secondary battery as claimed in claim 3, wherein the cover tape further comprises a second film layer on the first film layer.

5. The secondary battery as claimed in claim 4, wherein the second film layer comprises polyethylene terephthalate (PET).

6. The secondary battery as claimed in claim 4, wherein the first electrode tab and the cap assembly are welded together.

7. The secondary battery as claimed in claim 6, wherein the adhesive member is at one side of the first electrode tab and is on the second film layer.

8. The secondary battery as claimed in claim 1, wherein the adhesive member comprises acrylic.

9. The secondary battery as claimed in claim 1, wherein the cover tape is a first cover tape, and
wherein the electrode assembly further comprises a second electrode tab electrically connecting the second electrode to the case, and a second cover tape attaching the second electrode tab to the jelly roll.

10. The secondary battery as claimed in claim 9, wherein the adhesive member is a first adhesive member, and
wherein the secondary battery further comprises a second adhesive member between the second cover tape and a bottom portion of the case.

11. The secondary battery as claimed in claim 10, wherein the second cover tape comprises a first film layer that generates adhesive force by reacting with the electrolyte, and a second film layer on the first film layer.

12. The secondary battery as claimed in claim 1, wherein the jelly roll is wound into a cylindrical shape, and
wherein the secondary battery further comprises a securing tape attaching the jelly roll to a sidewall portion of the case.

13. The secondary battery as claimed in claim 12, wherein the securing tape is on an outer peripheral surface of the electrode assembly.

14. The secondary battery as claimed in claim 12, wherein the securing tape comprises a first film layer that generates adhesive force by reacting with the electrolyte.

15. A secondary battery comprising:
an electrode assembly comprising a jelly roll wound into a cylindrical shape, the jelly roll comprising a first electrode and a second electrode;
a cylindrical case comprising an opening at one side, the cylindrical case accommodating the electrode assembly and an electrolyte;
a cap assembly coupled to the opening of the case; and
a securing tape attaching the jelly roll to a sidewall portion of the case,
wherein the electrode assembly comprises:
a first electrode tab electrically connecting the first electrode to the cap assembly;
a cover tape comprising a first film layer that generates an adhesive force by reacting with the electrolyte to attach the first electrode tab to the jelly roll, and a second film layer on the first film layer; and
an adhesive member between the cover tape and the cap assembly.

16. The secondary battery as claimed in claim 15, wherein the first film layer comprises oriented polystyrene (OPS), and wherein the second film layer comprises polyethylene terephthalate (PET).

17. The secondary battery as claimed in claim 15, wherein the first electrode tab and the cap assembly are welded together, and
wherein the adhesive member is at one side of the first electrode tab and is on the second film layer.

18. The secondary battery as claimed in claim 15, wherein the cover tape is a first cover tape, and
wherein the electrode assembly further comprises a second electrode tab electrically connecting the second electrode to the case, and a second cover tape attaching the second electrode tab to the jelly roll.

19. The secondary battery as claimed in claim 18, wherein the adhesive member is a first adhesive member, and
wherein the secondary battery further comprises a second adhesive member between the second cover tape and a bottom portion of the case.

20. A secondary battery comprising:
an electrode assembly comprising a jelly roll wound into a cylindrical shape, the jelly roll comprising a first electrode and a second electrode;
a cylindrical case comprising an opening at one side end, the cylindrical case accommodating the electrode assembly and an electrolyte;
a cap assembly coupled to the opening of the case; and
a securing tape attaching the jelly roll to a sidewall portion of the case,
wherein the electrode assembly comprises:
a first electrode tab electrically connecting the first electrode to the cap assembly;
a second electrode tab electrically connecting the second electrode to the case;
a first cover tape comprising a first film layer that generates an adhesive force by reacting with the electrolyte to attach the first electrode tab to the jelly roll, and a second film layer on the first film layer;
a second cover tape comprising a first film layer that generates an adhesive force by reacting with the electrolyte to attach the second electrode tab to the jelly roll, and a second film layer on the first film layer;
a first adhesive member between the first cover tape and the cap assembly; and
a second adhesive member between the second cover tape and the bottom portion of the case.
